(19) United States
(12) Patent Application Publication
(10) Pub. No.: US 2015/0229487 A1
(43) Pub. Date: Aug. 13, 2015

(54) SYSTEMS AND METHODS FOR AUTOMATIC TRANSLATION OF AUDIO AND VIDEO DATA FROM ANY BROWSER BASED DEVICE TO ANY BROWSER BASED CLIENT

(71) Applicant: Talk Fusion, Inc., Brandon, FL (US)

(72) Inventors: Jason Lickliter, Frisco, TX (US); Jonathan Chen, Plano, TX (US)

(73) Assignee: Talk Fusion, Inc., Brandon, FL (US)

(21) Appl. No.: 14/589,701

(22) Filed: Jan. 5, 2015

Related U.S. Application Data
(60) Provisional application No. 61/938,931, filed on Feb. 12, 2014.

(51) Int. Cl. H04L 12/18; H04L 29/06

(52) U.S. Cl. CPC H04L 12/1827; H04L 65/601; H04L 67/42

(57) ABSTRACT

A platform-agnostic conferencing system including a media transceiver allowing a virtual collaboration and sharing system allowing a publisher to share media content to multiple viewers. Multiple participants are able to view the shared media, even if each is using different and incompatible platforms, by negotiating connections from differing protocols. Illustrative protocols include, but are not limited to, WebRTC, Flash, and HLC. Additionally, a mixer “multicasts” the content from one user and facilitates the retransmission to the participating differing end-users. Participant identities include an identifier for each participant engaging the collaboration space. The participants occupying the collaboration space can be automatically and dynamically determined. In this way participant roles can be changed from “publisher” to “viewer” and vice versa.

### FIELD OF INVENTION

This invention relates to the field of electronic media sharing and conferencing.

### BACKGROUND OF THE INVENTION

Video Communication is rapidly changing the way people and businesses interact. Billions of dollars are spent every year on Video Communication products, and traditional methods of doing business are becoming obsolete. Research suggests the unified communications (the integration of real-time communication services such as instant messaging, video conferencing, data sharing, etc.) market could soon be worth $ 10 billion. Video Conferencing is expected to grow to around $ 1 0.6 billion by 2016, with a growth rate of approximately 19.5%.

Current internet browser technology limits the number of users and types of users due to variations in hardware, software and device types thereof Users' participating in online live or saved events are required to install certain software to join or view the current event. Current limitations also include limiting the number of participants that can connect to a conferencing server simultaneously.

Current Peer to peer conferencing also has technical limitations where bandwidth and network access and speeds severely limit the number of participants and quality of the call.

WebRTC (Web Real-Time Communication) is an API definition to enable browser-to-browser applications for voice calling, video chat, and P2P file sharing without plugins.

### SUMMARY OF INVENTION

The invention provides a media type negotiation procedure involving an intermediate application server. This application server collects information on which media types each multimedia client involved in a. session are being used. From the collected information, the application server can receive multiple media formats, covert the media to an acceptable format, and transmit the converted file to an accepted type in order to achieve maximum interoperability.

The present invention includes implementation of a virtual collaboration or conference space containing multiple participants. Each collaboration participant can be defined by one or more key attributes, such as publisher or viewer. The key attributes, or roles, can be either relatively static attributes or dynamically changing attributes. As changes occur, membership within the collaboration space can dynamically change.

The invention includes a media transceiver allowing multiple participants to engage in a video conference, even if using incompatible platforms, by negotiating connections from differing protocols including, but not limited to, WebRTC, Flash, and HLC. Additionally, a mixer “multicasts” the content from one user and facilitates the retransmission to the participating differing end-users. The inventive system utilizes inventive RTC mixer middleware to extend existing RTC limitations to a common standard enabling communication.

Still another aspect of the present invention can include a virtual collaboration or conferencing interface including a participant list. Each participant on the participant can be associated with at least one identifier (e.g. role and/or supported media types) for each participant occupying the virtual space. The participants occupying the virtual space can be automatically and dynamically determined. The interface can include a graphical user interface section for composing or transmitting a message and/or a multimedia stream. The mechanism can convey the message and/or multimedia to all or preselected users occupying the virtual space.

It should also be noted that the methods detailed herein can also be methods performed at least in part by a service agent and/or a machine manipulated by a processor, in the form of a media transceiver, in response to a request to transmit a multimedia stream.

### BRIEF DESCRIPTION OF THE DRAWINGS

For a fuller understanding of the invention, reference should be made to the following detailed description, taken in connection with the accompanying drawings, in which:

FIG. 1 is a diagram wherein a publisher streams media content to a transceiver.

The transceiver receives requests from participants and negotiates compatible content streams;

FIG. 2 is a flowchart describing a typical information flow for service;

FIG. 3 is a diagram wherein a new publisher streams content to the transceiver. The transceiver receives requests from participants and negotiates compatible content streams;

FIG. 4 is a diagram of an illustrative embodiment of the invention.

FIG. 5 is a flowchart of an illustrative embodiment of the invention.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

Exemplary embodiments of the present invention are directed to a system and method for establishing one or more communications channels between participants to a virtual collaboration space or conference via a web browser. Such a system may be, for example, a Web real-time communication (WebRTC) system. WebRTC, which is also known as RTCWeb, enables a web browser to provide real-time communications (RTC) capabilities via JavaScript application programming interfaces (APIs) without requiring a participant to actively download and install additional software and essentially makes bidirectional media processing and media coding technologies available in every browser. WebRTC technology puts a media engine into a browser or other elements of client devices. The media engine is the technology that manages microphones, cameras, and speakers and gets audio and video onto and off the internet. Thus, a participant (in the role of a publisher) in the virtual conference desiring to transmit media to other participants simply initiates a request without requiring that the publisher to install any standalone applications or browser plug-in. The participant also need not leave his/her current web browsing session and initiate a separate call session for engaging in a web browser based collaboration space or conference. Importantly, as is required for true collaboration, multiple users can publish multimedia to the collaboration or conference space.

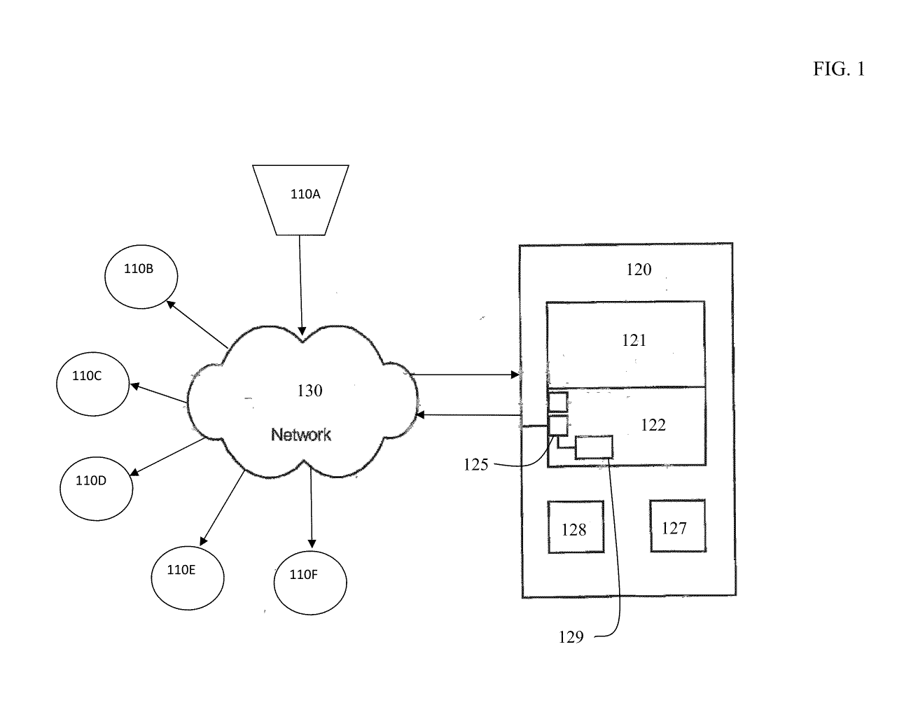

A functional architecture of a multimedia communication system implementing at least one embodiment of the invention is found in FIG. 1. The architecture allows for a plurality of multimedia clients, exemplified in FIG. 1 as publisher 110a, viewers 110b-110f, an Application Server 120 and a. network 130. The Application Server 120 can include a number of functional entities as a Session Signaling Unit 121 and a Media transceiver 122. The Session Signaling Unit 121 receives and sends signaling messages (e.g. SIP) from and to the Multimedia Clients 110. The Media Transceiver 122 has media control interfaces that receive and send media control signaling from and to the Multimedia Clients 110. The Media Transceiver 122 has Media Interfaces 125 that receives and sends the media streams from and to the Multimedia. Client 110. The Application Server 120 can, if necessary, replicate, convert or transcribe the media stream received from Multimedia Clients 110 to be retransmitted to other multimedia clients involved in a multimedia conversation through Media Transceiver 122. The Media Transceiver 122 can also terminate certain media types in the media stream received from Multimedia Client 110 that cannot be converted into media types supported by other multimedia clients. A mixer 129 “multicasts” the content from one user and facilitates the retransmission to the participating differing end-users. The Application Server 120 does also comprise Processor Logic 128 for processing session signaling and media control signaling and a Memory Area 127 for storing data, including sets of supported media types for each Multimedia Client 110.

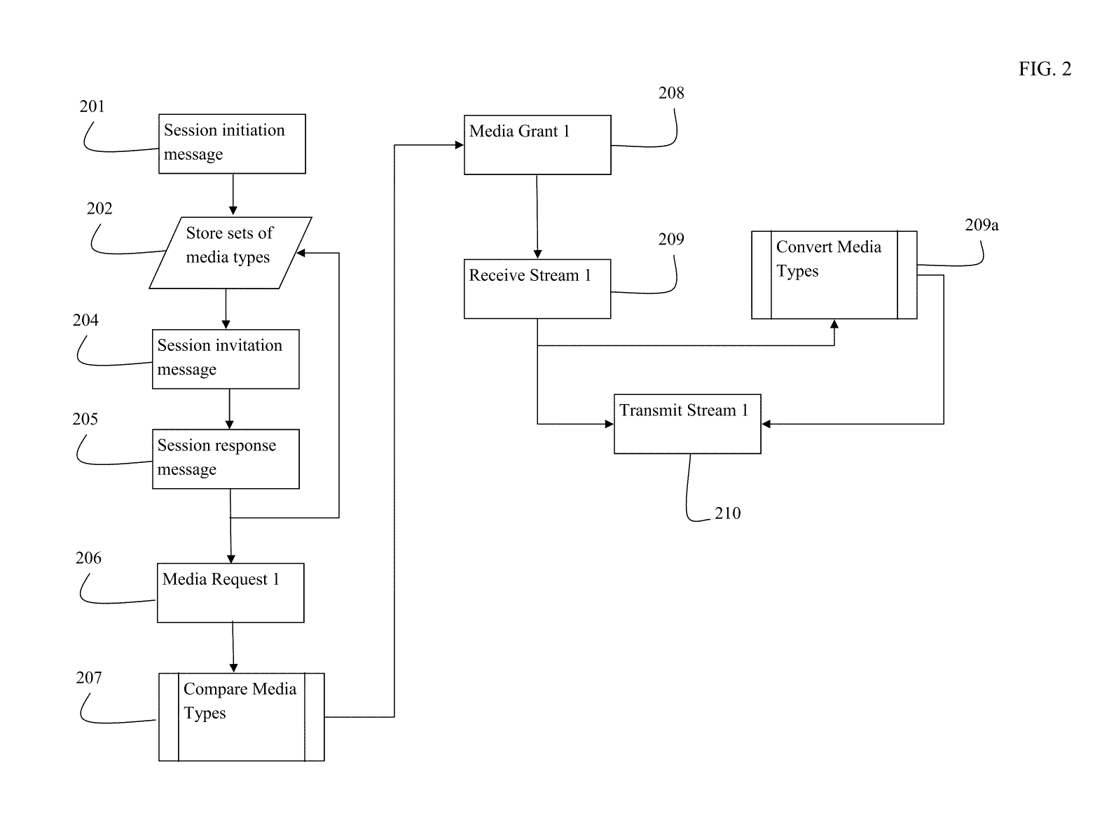

FIG. 2 illustrates a typical information flow for a service change as seen from the Application Server 120. The Application Server 120 receives a session initiation message 201 from a first multimedia client. The session invite message comprises a set of media types supported by the first multimedia client. This set is stored 202 in the Application Server 120. The Application Server 120 sends a session invite message 204 to a second multimedia client. Alternatively, The Application Server 120 receives a session join request message from a second multimedia client. If the second multimedia client connects to the session, it sends a session response message 205. The session response message 205 comprises a set of media types supported by the second multimedia client. This set is also stored 204 in the Application Server 120. The session initiation procedure can be repeated for each additional multimedia client that is invited to the session by the first multimedia client.

When any of the multimedia clients involved in the session, a requesting multimedia client, desires to start to transmit a media stream (e.g. video) to the other multimedia clients the requesting multimedia client sends a first media request 206. This first media request 206 comprises a first set of requested media types. As the Application Server 120 has knowledge of supported media types for the other multimedia clients, the Application Server 120 compares 207 the first set of requested media types with all the sets of media types supported by the other multimedia clients and grants the request by responding with a media grant 208 with a first set of allowed media types. The requesting multimedia client can now transmit a media flow on the media channel with media types according to the first set of allowed media types. The media flow is received 209 by the Application Server 120 and is replicated (if necessary) and re-transmitted 210 to the other multimedia clients.

However, if the first set of requested media types is incompatible with any of the Multimedia Clients, the media stream is converted to a compatible media type. The requesting multimedia client can now transmit a media flow on the media channel with media types according to the first set of allowed media types. The media flow is received 209 by the Application Server 120 and is converted 209a (if necessary) and re-transmitted 210 to the other multimedia clients.

During the conversation, the requesting multimedia client desires to modify the media flow (e.g. by adding video to an existing voice conversation). The requesting multimedia client sends a second media request to the Application Server 120 comprising a second set of requested media types. The Application Server compares the second set of requested media types with all the sets of media types supported by the other multimedia clients, and grants the request with a second media grant. This second media grant comprises a second set of allowed media types. The requesting media client can now transmit a modified media flow on the media channel with media types according to the second set of allowed media types. The media flow is received by the Application Server, replicated (if necessary), and re-transmitted to the other multimedia clients. If media types are incompatible, the media stream is converted, as above, prior to retransmission.

By way of example, FIGS. 1 and 2 represent a scenario wherein participant A is the publisher using a compatible WebRTC client with multiple viewers (110B-110F). Publisher 110A's stream is passed to the transceiver 122 where it is multi-casted and translated to the various viewers' capabilities. Transceiver 122 receives requests from participants B through F and negotiates compatible content streams.

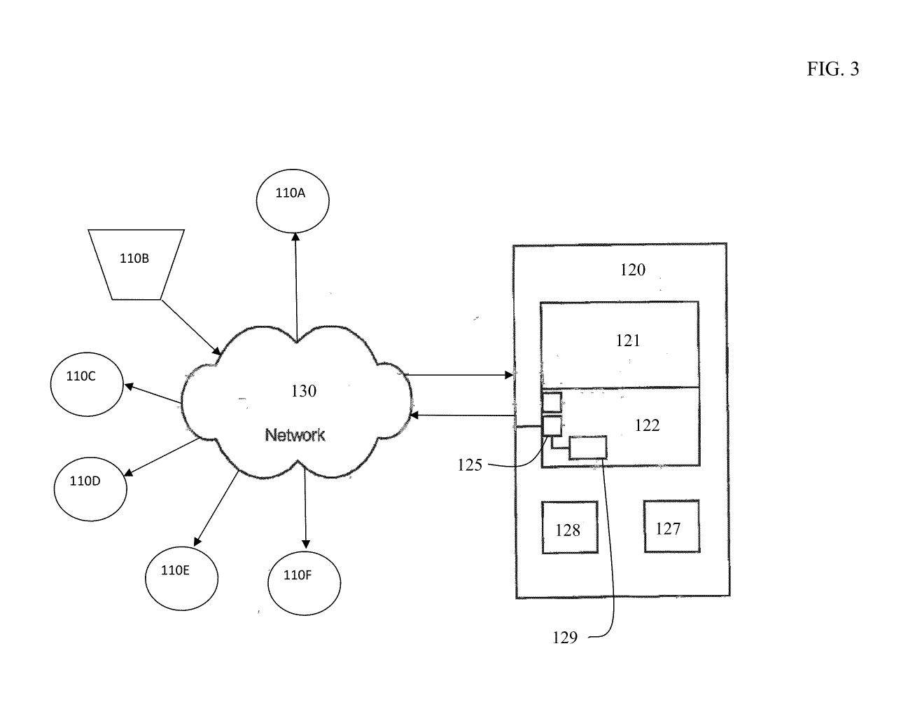

In FIG. 3, when a new presenter is desired, transceiver 122 receives the stream from viewer 110B (FIG. 1) to publisher 110B (FIG. 2) while the original presenter (publisher 110A, FIG. 1) converts to viewer mode (viewer 110A, FIG, 2). Participant “110B” thereby assumes the role of the publisher, while participant “110A” becomes a viewer and the multicasting/transcoding process continues normally. The multi-caster mixes RTC and non-RTC devices in a collaborative environment.

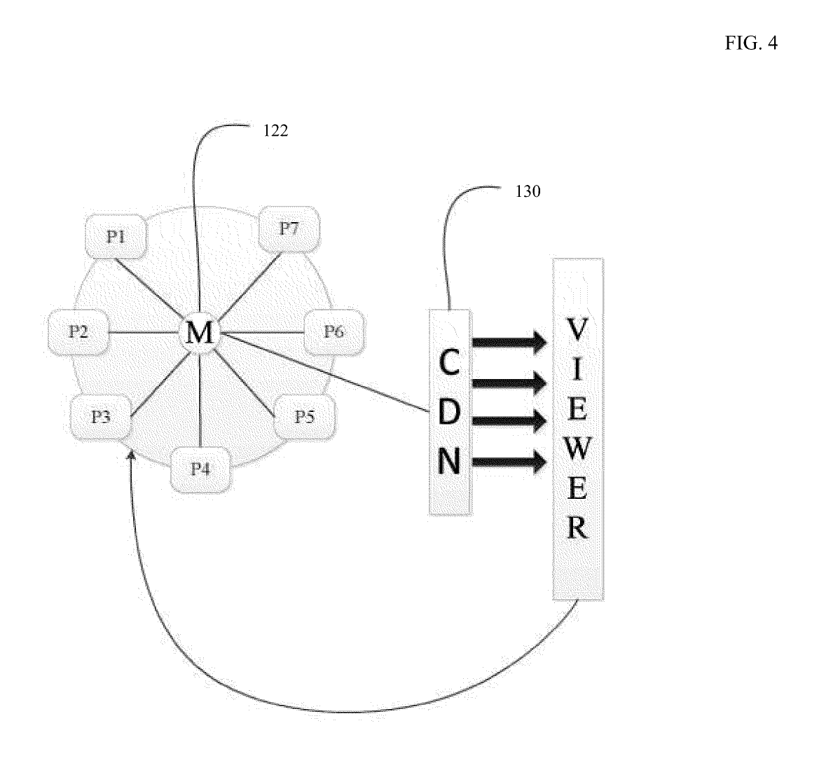

The Web RTC Transceiver 122 is a software platform that provides real time routing of participants in a video call based on their equipment capabilities. As shown in FIG. 4, transceiver 122 facilitates connecting users to the conference by determining their capabilities and the routing them to the appropriate media origin to participate through the use of multiple nodes (P1-P7). The WebRTC standard has many implementation changes based on browser, OS and device type thereof

Transceiver 122 manages the connections and allows anyone to join from any browser or device whether they are WebRTC compatible or are another socket-based device. Transceiver 10 manages connections and re-transmits the publisher content to the viewer connection based (via content delivery network 130) on the compatible offer of the medium and compatible codecs allowed of the viewer. This allows one user to publish their audio/video stream to many devices using the transceiver as a relay without being concerned about compatibility of protocols or media types. When joining a session the transceiver 10 decodes the many types of standards available and offers to deliver the content in the format the viewer can decode.

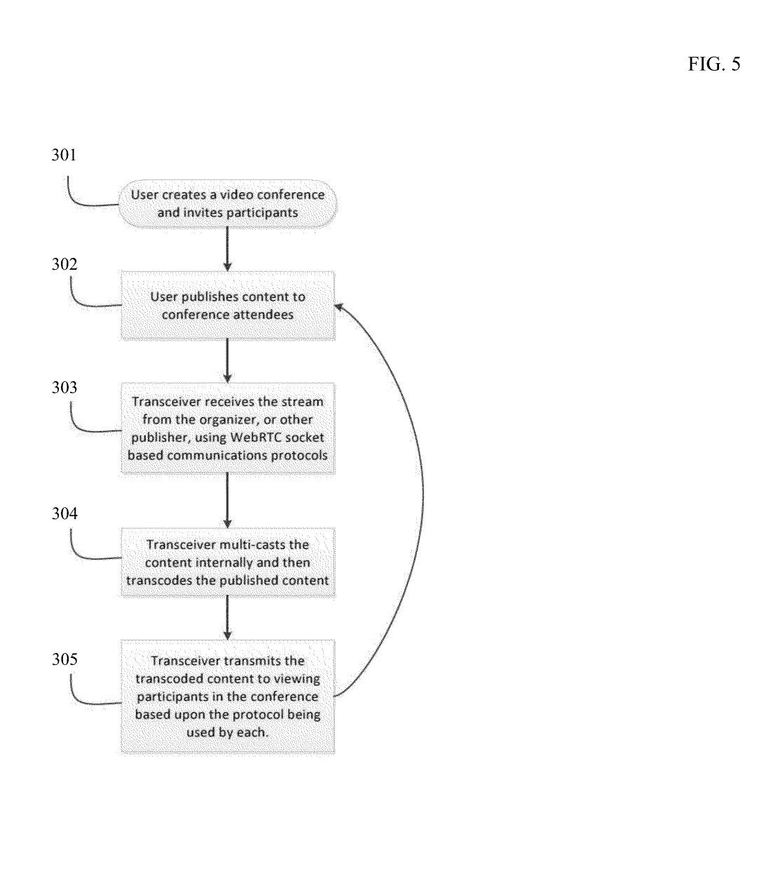

Referring now to FIG. 5, transceiver operates as follows:

Step 1 (301) a user creates a video conference and invites participants thereby establishing a communication channel. In step 2 (302), the user publishes content to conference attendees. Step 3 (303), the transceiver receives the stream from the organizer, or other publisher, using WebRTC socket based communications protocols. Step 4 (304), the transceiver multi-casts the content internally and then transcodes the published content. Finally, in step 5 (305), the transceiver transmits the transcoded content to viewing participants in the conference based upon the protocol being used by each.

The step of establishing the communication channel may include identifying a user session using a session identifier. The communication channel may include a WebRTC call leg, an SIP call leg, a PSTN call leg, a WebRTC call leg an audio channel and/or a video channel.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A method for providing different services in a multimedia communication system that includes an application server and a plurality of multimedia clients the method comprising the following steps:
a. receiving from a first multimedia client a request to initiate a multimedia conversation with at least a second multimedia client;
b. receiving from the first multimedia client a set of media types supported by said first multimedia client;
c. sending to the second multimedia client a request to invite said second multimedia client to be part of the multimedia conversation;
d. receiving from the second multimedia client a set of media types supported by said second multimedia client;
e. storing the sets of media types supported by the first and the second multimedia clients;
f. receiving from a request from the first or second multimedia client a publisher request;
g. designating the first or second multimedia client as a publisher;
h. receiving a first multimedia stream from the publisher in the form a first media type;
i. converting, at a processor, the first multimedia stream in the form of the first media type to a first multimedia stream in the form of a second media type supported by the second multimedia client; and
j. re-transmitting the first media stream in the form of a second media type supported by the second multimedia client to the second multimedia client.

2. The method of claim 1, further comprising the steps of:
a. receiving a second publisher request from the first or second multimedia client;
b. designating the first publisher as a viewer; and
c. designating the sender of the second publisher request as a second publisher.

3. The method of claim 1, wherein the request to initiate the multimedia conversation is initiated by a first web browser application and the set of media types supported by said first multimedia client includes at least a first media codec supported by the first web browser.

4. The method of claim 3, wherein the request to initiate the multimedia conversation is received at the second multimedia client by a second web browser application and the set of media types supported by said the second multimedia client includes at least a first media codec supported by the second web browser.

5. The method of claim 4, wherein the first media codec of the first and second web browsers includes a voice-over-IP codec for engaging in a voice-over-IP call.

6. The method of claim 1, further comprising the steps of:
a. receiving from the first multimedia client a request to initiate a multimedia conversation with a third multimedia client;
b. sending to the third multimedia client a request to invite said third multimedia client to be part of the multimedia conversation;
c. receiving from the third multimedia client a set of media types supported by said third multimedia client;
d. storing the sets of media types supported by the third multimedia client with the first and the second multimedia clients;
e. designating the third multimedia client as a viewer;
f. receiving a first multimedia stream from the first publisher in the form a first media type;
g. converting, at a processor, the first multimedia stream in the form of the first media type to a first multimedia stream in the form of a second media type supported by the second multimedia client;
h. re-transmitting the first media stream in the form of the second media type supported by the second multimedia client to the second multimedia client;
i. converting, at a processor, the first multimedia stream in the form of the first media type to a second multimedia stream in the form of a third media type supported by the third multimedia client; and
j. re-transmitting the first media stream in the form of the second media type supported by the second multimedia client to the second multimedia client.

7. The method of claim 6, further comprising the steps of:
a. receiving a second publisher request from the first, second or third multimedia client;
b. designating the first publisher as a viewer; and
c. designating the sender of the second publisher request as a second publisher.

8. The method of claim 6, wherein:
a. the request to initiate the multimedia conversation is initiated by a first web browser application and the set of media types supported by said first multimedia client includes at least a first media codec supported by the first web browser;
b. the request to initiate the multimedia conversation is received at the second multimedia client by a second web browser application and the set of media types supported by said the second multimedia client includes at least a first media codec supported by the second web browser; and
c. the request to initiate the multimedia conversation is received at the third multimedia client by a third web browser application and the set of media types supported by said the third multimedia client includes at least a first media codec supported by the third web browser.

9. The method of claim 8, wherein the first media codec of the first, second and third web browsers includes a voice-over-IP codec for engaging in a voice-over-IP call.

10. A system for providing different services in a multimedia conversation, the system comprising:
a. a processor; and
b. a memory, wherein the memory stores instructions that, when executed by the processor, cause the processor to:
i. receive from a first multimedia client a request to initiate a multimedia conversation with at least a second multimedia client;
ii. receive from the first multimedia client a set of media types supported by said first multimedia client;
iii. send to the second multimedia client a request to invite said second multimedia client to be part of the multimedia conversation;
iv. receive from the second multimedia client a set of media types supported by said second multimedia client;
v. store the sets of media types supported by the first and the second multimedia clients;
vi. receive from a request from the first or second multimedia client a publisher request;
vii. designate the first or second multimedia client as a publisher;
viii. receive a first multimedia stream from the publisher in the form a first media type;
ix. convert the first multimedia stream in the form of the first media type to a first multimedia stream in the form of a second media type supported by the second multimedia client; and
x. re-transmit the first media stream in the form of a second media type supported by the second multimedia client to the second multimedia client.

11. The system of claim 10 wherein the memory stores instructions that, when executed by the processor, cause the processor to:
a. receive a second publisher request from the first or second multimedia client;
b. designate the first publisher as a viewer; and
c. designate the sender of the second publisher request as a second publisher.

12. The system of claim 10 wherein the first multimedia client includes a first web browser application and the set of media types supported by said first multimedia client includes at least a first media codec supported by the first web browser.

13. The system of claim 10 wherein the second multimedia client includes a second web browser application and the set of media types supported by said second multimedia client includes at least a first media codec supported by the second web browser.

14. The system of claim 10 wherein the memory stores instructions that, when executed by the processor, cause the processor to:
a. receive from the first multimedia client a request to initiate a multimedia conversation with a third multimedia client;
b. send to the third multimedia client a request to invite said third multimedia client to be part of the multimedia conversation;
c. receive from the third multimedia client a set of media types supported by said third multimedia client;
d. store the sets of media types supported by the third multimedia client with the first and the second multimedia clients;
e. designate the third multimedia client as a viewer;
f. receive a first multimedia stream from the first publisher in the form a first media type;
g. convert the first multimedia stream in the form of the first media type to a first multimedia stream in the form of a second media type supported by the second multimedia client;
h. re-transmit the first media stream in the form of the second media type supported by the second multimedia client to the second multimedia client;
i. converting the first multimedia stream in the form of the first media type to a second multimedia stream in the form of a third media type supported by the third multimedia client; and
j. re-transmit the first media stream in the form of the second media type supported by the second multimedia client to the second multimedia client.

15. The system of claim 14 wherein:
a. the first multimedia client includes a first web browser application and the set of media types supported by said first multimedia client includes at least a first media codec supported by the first web browser;
b. the second multimedia client includes a second web browser application and the set of media types supported by said second multimedia client includes at least a first media codec supported by the second web browser; and
c. the third multimedia client includes a third web browser application and the set of media types supported by said third multimedia client includes at least a first media codec supported by the third web browser.
